(19) United States
(12) Patent Application Publication
(10) Pub. No.: US 2026/0023374 A1
(43) Pub. Date: Jan. 22, 2026

(54) WELL SYSTEM ELECTRICAL SUBMERSIBLE PUMP EQUIPMENT FAILURE ANALYSIS

(71) Applicant: Halliburton Energy Services, Inc., Houston, TX (US)

(72) Inventors: Christina Marie Harrington, Tulsa, OK (US); Frank Corredor, Houston, TX (US); Jeffrey Bridges, Tulsa, OK (US)

(21) Appl. No.: 18/776,641

(22) Filed: Jul. 18, 2024

(51) Int. Cl. G05B 23/02; G06N 20/20

(52) U.S. Cl. CPC G05B 23/0248; G06N 20/20; G05B 2223/04

(57) ABSTRACT

Techniques for electrical submersible pump equipment fault analysis include training, using first training data, one or more machine learning models to categorize previously unseen images of electrical submersible pump equipment into one or more categories of a plurality of categories. The techniques further include training, using second training data, the one or more machine learning models to generate captions for the previously unseen images of electrical submersible pump equipment.

### BACKGROUND

Failure analysis performed on electrical submersible pump equipment includes evaluating the condition of the equipment at multiple stages, including assembly, testing, installation, removal, and when dismantled. Knowledge of causes and interpretation of damage and/or wear incurred is limited to domain subject matter experts who have previous experience with particular conditions relevant to a particular failure, thus limiting the number of people who may properly diagnose failures.

### BRIEF DESCRIPTION OF THE DRAWINGS

Embodiments of the disclosure may be better understood by referencing the accompanying drawings.

FIG. 1 is a diagrammatic illustration of an example well system, according to some implementations.

FIG. 2 is an illustration of an example system for training a categorizing machine learning module, according to some implementations.

FIG. 3 is an illustration of an example system for training a caption-generating machine learning module, according to some implementations.

FIG. 4 is an illustration of an example system for training a failure cause-generating machine learning module, according to some implementations.

FIG. 5 is an illustration of an example system for training a reliability-report-generating machine learning module, according to some implementations.

FIG. 6 depicts a system for analyzing images of electrical submersible pumps equipment using one or more machine learning models, according to some implementations.

FIG. 7 depicts a flow diagram illustrating operations performed to train one or more machine learning models to work with electrical submersible pumps equipment images, according to some implementations.

FIG. 8 depicts a flow diagram illustrating operations for analyzing electrical submersible pumps equipment images using one or more trained machine learning models, according to some implementations.

FIG. 9 is a block diagram depicting an example computer, according to some implementations.

### DESCRIPTION

The description that follows includes example systems, methods, techniques, and program flows that embody aspects of the disclosure. However, it is understood that this disclosure may be practiced without these specific details. In some instances, well-known instruction instances, protocols, structures, and techniques have not been shown in detail in order not to obfuscate the description.

Electrical submersible pumps and related equipment (“ESP equipment”) have data associated with them that may be useful in diagnosing problems. For example, ESP equipment may have specifications, the well system(s) in which the ESP equipment is used may have various features (e.g., depth, operating pressures, etc.), and reliability reports may be created in response to previous ESP equipment failures. This and other data may be useful in determining the cause of an ESP equipment failure.

In some implementations, one or more machine learning models can be trained on the data associated with ESP equipment to help improve failure analysis of ESP equipment. The data may include reliability reports created during previous failure analyses, images associated with the ESP equipment, ESP equipment specifications, information about ESP equipment usage conditions, etc. When subsequent failures occur to ESP equipment, images of the failed ESP equipment can be provided as input to the machine learning models. The machine learning models can categorize the images based on the subject matter contained therein and may generate captions for the images indicating various properties of the subject matter contained therein.

In some implementations, a failure diagnostic tool is based, at least in part, on one or more machine learning models. Each machine learning model can be trained on data related to ESP equipment, such as reliability reports and images (including photographs) of ESP equipment. The failure diagnostic tool may be used by engineers to assist in identifying types of damage and/or wear and the cause(s) of the failure. For example, an engineer may use a photograph taken of one or more pieces of ESP equipment during disassembly as input to the failure diagnostic tool. The failure diagnostic tool may generate one or more potential captions based, at least in part, on the subject matter in the photograph and may also generate indications of one or more potential causes of failure.

In some implementations, the one or more machine learning models implement operations to categorize images associated with the ESP equipment into one or more categories. The images may be photographs taken of the ESP equipment from one or more points in the life of the ESP equipment, including assembly, testing, installation, removal, dismantling/disassembly, etc.

In some implementations, the one or more machine learning models implement operations to identify indications of wear and/or damage and/or one or more causes of failure based, at least in part, on one or more images. The images may be photographs taken of the ESP equipment from one or more points in the life of the ESP equipment, including assembly, testing, installation, removal, dismantling/disassembly, etc.

In some implementations, a library of images and associated data (e.g., image captions) is used to train one or more machine learning models (e.g., a deep-learning models) that can work with image and text data. Some examples of machine learning models that can work with image and text data include long-short-term-memory models, recurrent neural network models, convolution neural network models, etc. Each image has one or more captions associated with it and the chosen machine learning model is capable of determining the meaning of the caption using natural language processing (NLP) techniques. The NLP techniques may be implemented by the one or more machine learning models or implemented by a separate module working in conjunction with the one or more machine learning models. The chosen machine learning model is capable of reading images of varying size and with a color dimension.

In some implementations, a machine learning model is trained using data that has been categorized into a plurality of categories. The categories may be pre-defined or may be determined using a machine learning model, deep learning algorithm, etc. The trained machine learning model is then usable to categorize each image in the library of images into one or more categories of the plurality of categories. For example, the plurality of categories may include the subject of the image, the stage of the drilling job, etc. The machine learning model (or a related module) may utilize NLP (such as sentiment analysis), object detection, classification, and other techniques to categorize the images.

In some implementations, once the one or more machine learning models are trained on the images and associated data, additional images may be provided as input to the one or more machine learning models which may then perform one or more operations to categorize the images, generate one or more captions for the images, generate a failure cause based, at least in part, on the images, etc. The one or more machine learning models may also generate an instance of a confidence metric associated with each of the results.

An example implementation might comprise a set of training data associated with ESP equipment and an untrained categorizing machine learning model. The training data may comprise a large variety of data associated with ESP equipment. In this example, the training data falls into at least four broad categories: images (including photographs) of ESP equipment, ESP equipment specifications, well system parameters, and reliability reports. The reliability reports may combine the equipment specifications, well system parameters, and the images of the ESP equipment with other graphical and textual data, such as image captions, descriptions of equipment conditions/wear/damage, plots of ESP equipment operational history, etc.

The untrained categorizing machine learning model is trained to categorize previously unseen images of the ESP equipment into one or more categories of a plurality of categories based, at least in part, on the reliability reports, ESP equipment specifications, or the well system parameters. The training of the untrained categorizing machine learning model results in a trained categorizing machine learning model that can take previously unseen images of ESP equipment and categorize them according to one or more categories of the plurality of categories. The training process may utilize techniques such as object detection and NLP to assist in identifying relationships usable to categorize the images of the ESP equipment.

For example, assume the training data consists of a large number of reliability reports and the reliability reports frequently include photographs of intake screens removed from electrical submersible pumps with captions like “intake screen clear of debris” or “intake screen clogged with debris”. The training process may utilize text recognition techniques to read the captions from the images and NLP techniques to parse the captions. The training process may also use image processing techniques, object detection techniques, and the like to train the untrained categorizing machine learning model to identify intake filters in the photographs of the ESP equipment. The training process may further train the untrained categorizing machine learning model to identify whether the intake filters in the photographs of the ESP equipment are clear or clogged by utilizing the parsed captions. The trained categorizing machine learning model may thus be able to take a previously unseen photograph of ESP equipment and categorize the photograph as a clogged intake screen or unclogged intake screen.

As another example, the reliability reports may include model numbers associated with the individual components of an electrical submersible pump. The training process may result in a trained categorizing machine learning model that is capable of categorizing previously unseen images of ESP equipment into categories corresponding to the model(s) of the electrical submersible pump shown in the images.

As another example, the reliability reports may include failure causes that specify the reasons ESP equipment has failed or may have failed in the future. The training process may result in a trained categorizing machine learning model that is capable of categorizing previously unseen images of ESP equipment into categories corresponding to failure causes that are typically associated with features of the images of the ESP equipment. For example, if images of clogged intake screens frequently appear in reliability reports that have a failure cause of “improper sand size,” the trained categorizing machine learning model may categorize previously unseen images of clogged intake screens as being associated with improper sand sizes.

The plurality of categories may be pre-determined or may be created using automated methods. For example, instead of including pre-determined categories as part of the training data, the training process may be configured to cluster the photographs of the ESP and then the clusters may be used as the plurality of categories.

The example implementation might also comprise an untrained caption-generating machine learning model. The untrained caption-generating machine learning model is trained to generate one or more captions for previously unseen images of ESP equipment. The training of the untrained caption-generating machine learning model can use the same training data as used to train the untrained categorizing machine learning model or different training data. For example, the training data for training the untrained caption-generating machine learning model may be images of ESP equipment along with one or more captions corresponding to one or more of the images of the ESP equipment.

Captions may come in different forms. For example, in some instances, captions may be text located in close proximity to an image embedded in a document, such as a line of text directly under the image and separated from the main body text. In some instances, captions may be text overlaid on the original image. In some instances, captions may be embedded into metadata associated with the image.

When the captions are text overlaid on the original image, optical character recognition, NLP, and other techniques can be used to identify the text in the image and turn the captions into computer-readable text.

NLP techniques may further be used to transform the captions for use as training data or may be incorporated in the untrained caption-generating machine learning model itself.

After the training process, the trained caption-generating machine learning model may be capable of performing one or more operations to generate captions for previously unseen images of ESP equipment. For example, if the images of ESP equipment frequently contain photographs of clogged intake screens with captions like “intake screen clogged with debris,” the trained caption-generating machine learning model may be capable of receiving a previously unseen and uncaptioned image of a clogged intake screen and generate the caption “intake screen clogged with debris.”

The caption-generating machine learning model may be implemented to work based on the plurality of categories, based on the images of the ESP equipment directly, a combination thereof, or using other data. For example, in some implementations, the caption-generating machine learning model may be implemented such that it receives the output of the trained categorizing machine learning model (one or more categories of the plurality of categories) and generates a caption based on the output of the trained categorizing machine learning model. As another example, in some implementations, the caption-generating machine learning model may be implemented to receive an image of ESP equipment and generate a caption based on the image of the ESP equipment.

The trained caption-generating machine learning model may generate the captions as human readable text, which may then be associated with the input image (e.g., using a data structure like a map or by adding the text as an overlay on the original image).

The example implementation might also comprise an untrained failure cause-generating machine learning model. The untrained failure cause-generating machine learning model is trained to generate one or more failure causes based, at least in part, on one or more previously unseen images of ESP equipment. The training of the untrained failure cause-generating machine learning model can use the same training data as used to train the untrained categorizing machine learning model or different training data. For example, the training data for training the untrained failure cause-generating machine learning model may be images of ESP equipment along with the reliability reports. As another example, the failure causes specified in the reliability reports may be extracted along with the images in the reliability reports. Each sample of the training data might then consist of one or more images from a particular reliability report mapped to one or more failure causes from the same reliability report.

The example implementation might also comprise an untrained reliability report-generating machine learning model. The untrained reliability report-generating machine learning model is trained to generate reliability reports based, at least in part, on one or more previously unseen images of ESP equipment. The training of the untrained reliability report-generating machine learning model can use the same training data as used to train the untrained categorizing machine learning model or different training data. For example, the training data for training the untrained reliability report-generating machine learning model may be images of ESP equipment along with reliability reports containing the images of the ESP equipment.

The training process may result in a trained reliability report-generating machine learning model that can generate descriptive text, image captions, and failure causes based on one or more previously unseen images of ESP equipment.

### Example Well System

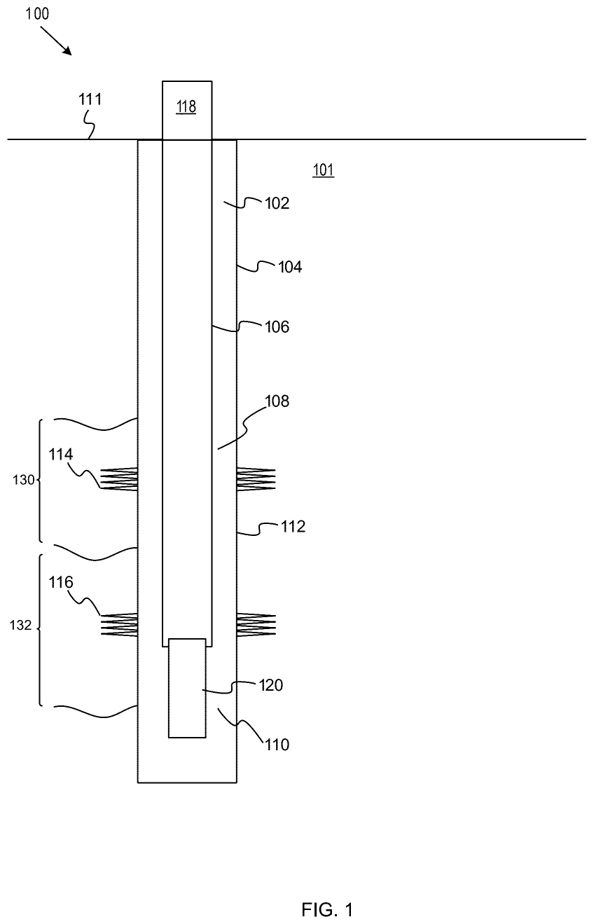

FIG. 1 is a diagrammatic illustration of an example well system, according to some implementations. In particular, FIG. 1 depicts a well system 100 that comprises a wellbore 102 in a formation 101. The wellbore 102 includes a casing 104 and a number of perforations 114, 116 in the casing 104. Each set of perforations 114, 116 is made in a corresponding stage of a set of stages 130 and 132 to allow reservoir fluids (i.e., oil, water, and gas) from the formation 101 to flow into the wellbore 102 and into the tubular string 106 (the production tubing).

The well system 100 includes a wellhead 118 located on a pad 111. The pad 111 may include a variety of equipment that varies depending on the stage of the operation, some of which may be part of the wellhead 118. The well system 100 also includes ESP equipment 120. The ESP equipment (including the electrical submersible pump itself) may be part of or coupled with the tubular string 106.

### Example Computing Systems

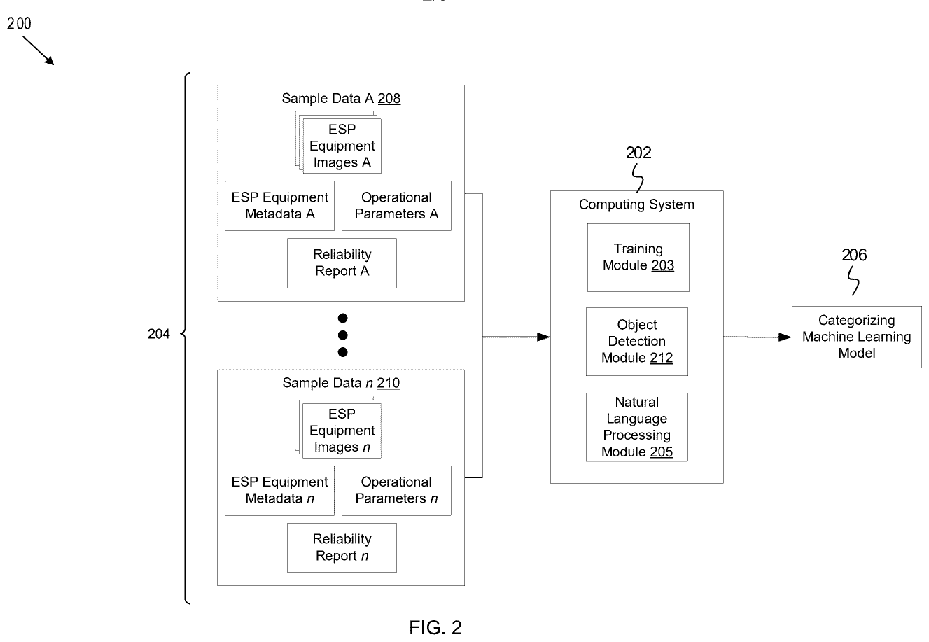

FIG. 2 is an illustration of an example system for training a categorizing machine learning module, according to some implementations. In particular, FIG. 2 depicts an example system 200 including a computing system 202, training data 204, and a categorizing machine learning model 206. The computing system 202 includes a training module 203, an object detection module 212, and a natural language processing module (“NLP processing module”) 205. The training data 204 consists of sets of samples data A through n (represented by sample data A 208 and sample data n 210). The categorizing machine learning model 206 can implement operations to categorize images of ESP equipment.

Sample data A 208 includes ESP equipment images A, ESP equipment metadata A, operational parameters A, and a reliability report A. Sample data n 210 includes ESP equipment images n, ESP equipment metadata n, operational parameters n, and a reliability report n. Actual implementations need not include all of the data depicted and may include additional data not depicted.

In operation, the training data 204 is provided to, or retrieved by, the computing system 202. The computing system 202 provides the training data 204 as input to the training module 203, which then executes one or more operations to train the categorizing machine learning model 206.

The training module 203 may use, or work in conjunction with, the object detection module 212. For example, the object detection module 212 may detect objects in the ESP equipment images A, such as impellers, shafts, and motors, and then provide indications of the detected objects to the training module 203. The detected objects may thus supplement the training data 204.

Similarly, the training module 203 may use, or work in conjunction with, the NLP module 205. For example, the NLP module 205 may identify and process text in captions embedded in the ESP equipment images A, ESP equipment metadata A, and reliability reports A, and then provide the processed text to the training module 203. The identified and processed text may thus supplement the training data 204.

Once training is complete, the training module 203 outputs the categorizing machine learning model 206. The categorizing machine learning model 206 can include multiple trained machine learning models as well as code usable to perform the categorization operations described herein.

Although not required, the categorizing machine learning model 206 is typically persisted to a machine-readable storage medium, such as a hard drive or an object store in the cloud.

Actual implementations may not include an object detection module 212 or NLP module 205 and may include additional modules useful for processing and supplementing the training data 204.

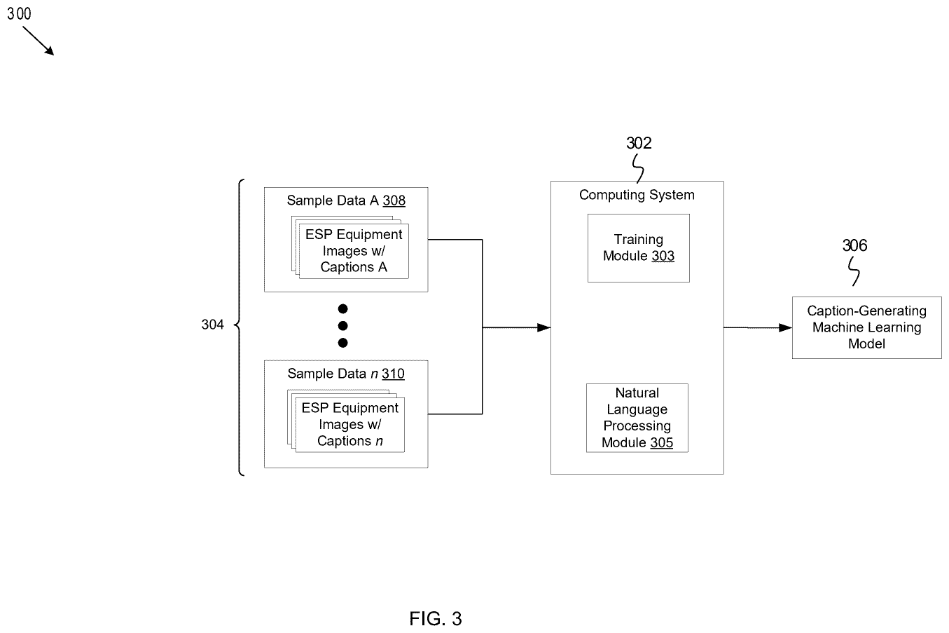

FIG. 3 is an illustration of an example system for training a caption-generating machine learning module, according to some implementations. In particular, FIG. 3 depicts an example system 300 including a computing system 302, training data 304, and a caption-generating machine learning model 306. The computing system 302 includes a training module 303 and a natural language processing module (“NLP processing module”) 305. The training data 304 consists of sets of samples data A through n (represented by sample data A 308 and sample data n 310). The caption-generating machine learning model 306 can implement operations to generate captions corresponding to images of ESP equipment.

Sample data A 308 includes ESP equipment images with captions A and sample data n 310 includes ESP equipment images with captions n. Actual implementations need not include all of the data depicted and may include additional data not depicted. For example, the ESP equipment images may be embedded in a reliability report that includes text-based captions in proximity to the ESP equipment images. In such cases the sample data may be the reliability reports.

In operation, the training data 304 is provided to, or retrieved by, the computing system 302. The computing system 302 provides the training data 304 as input to the training module 303, which then executes one or more operations to train the caption-generating machine learning model 306.

The training module 303 may use, or work in conjunction with, the NLP module 305. For example, the NLP module 305 may identify and process text in captions embedded in the ESP equipment images A and provide the identified and processed captions to the training module 303. As another example, if the ESP equipment images provided in the training data 304 are embedded in reliability reports, the NLP module 305 may identify portions of the reliability reports that refer to the images then process the corresponding text and provide the identified and processed text to the training module 303. The identified and processed text may thus supplement the training data 304.

Once training is complete, the training module 303 outputs the caption-generating machine learning model 306. The caption-generating machine learning model 306 can include multiple trained machine learning models as well as code usable to perform the categorization operations described herein.

Although not required, the caption-generating machine learning model 306 is typically persisted to a machine-readable storage medium, such as a hard drive or an object store in the cloud.

Actual implementations may not include an NLP module 205 and may include additional modules useful for processing and supplementing the training data 304.

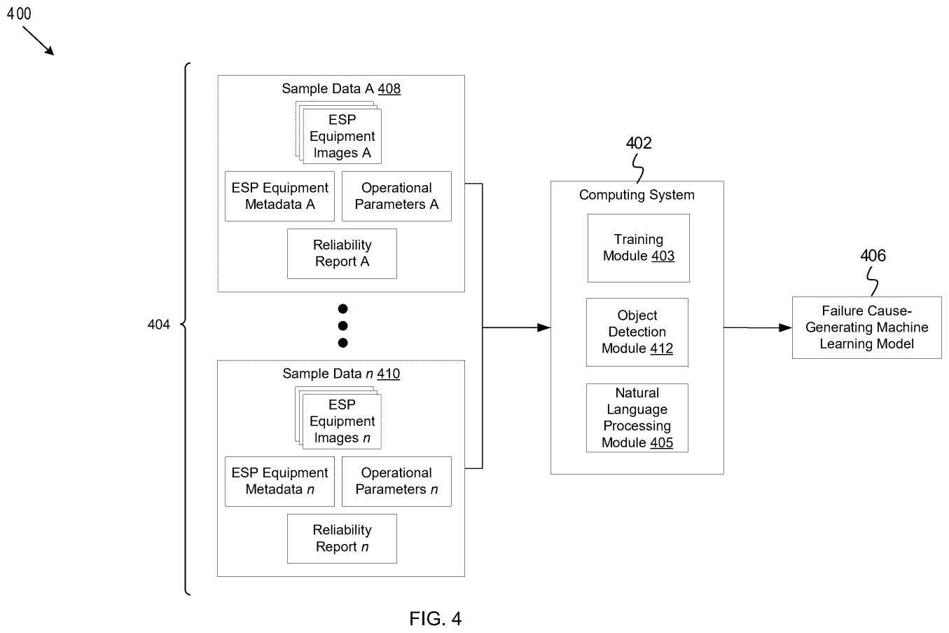

FIG. 4 is an illustration of an example system for training a failure cause-generating machine learning module, according to some implementations. In particular, FIG. 4 depicts an example system 400 including a computing system 402, training data 404, and a failure cause-generating machine learning model 406. The computing system 402 includes a training module 403, an object detection module 412, and a natural language processing module (“NLP processing module”) 405. The training data 404 consists of sets of samples data A through n (represented by sample data A 408 and sample data n 410). The failure cause-generating machine learning model 406 can implement operations to generate failure causes associated with ESP equipment.

Sample data A 408 includes ESP equipment images A, ESP equipment metadata A, operational parameters A, and a reliability report A. Sample data n 410 includes ESP equipment images n, ESP equipment metadata n, operational parameters n, and a reliability report n. Actual implementations need not include all of the data depicted and may include additional data not depicted.

In operation, the training data 404 is provided to, or retrieved by, the computing system 402. The computing system 402 provides the training data 404 as input to the training module 403, which then executes one or more operations to train the failure cause-generating machine learning model 406.

The training module 403 may use, or work in conjunction with, the object detection module 412. For example, the object detection module 412 may detect objects in the ESP equipment images A, such as impellers, shafts, and motors, and then provide indications of the detected objects to the training module 403. The detected objects may thus supplement the training data 404.

Similarly, the training module 403 may use, or work in conjunction with, the NLP module 405. For example, the NLP module 405 may identify and process text in captions embedded in the ESP equipment images A, ESP equipment metadata A, and reliability reports A, and then provide the processed text to the training module 403. The identified and processed text may thus supplement the training data 404.

Once training is complete, the training module 403 outputs the failure cause-generating machine learning model 406. The failure cause-generating machine learning model 406 can include multiple trained machine learning models as well as code usable to perform the categorization operations described herein.

Although not required, the failure cause-generating machine learning model 406 is typically persisted to a machine-readable storage medium, such as a hard drive or an object store in the cloud.

Actual implementations may not include an object detection module 412 or NLP module 405 and may include additional modules useful for processing and supplementing the training data 404.

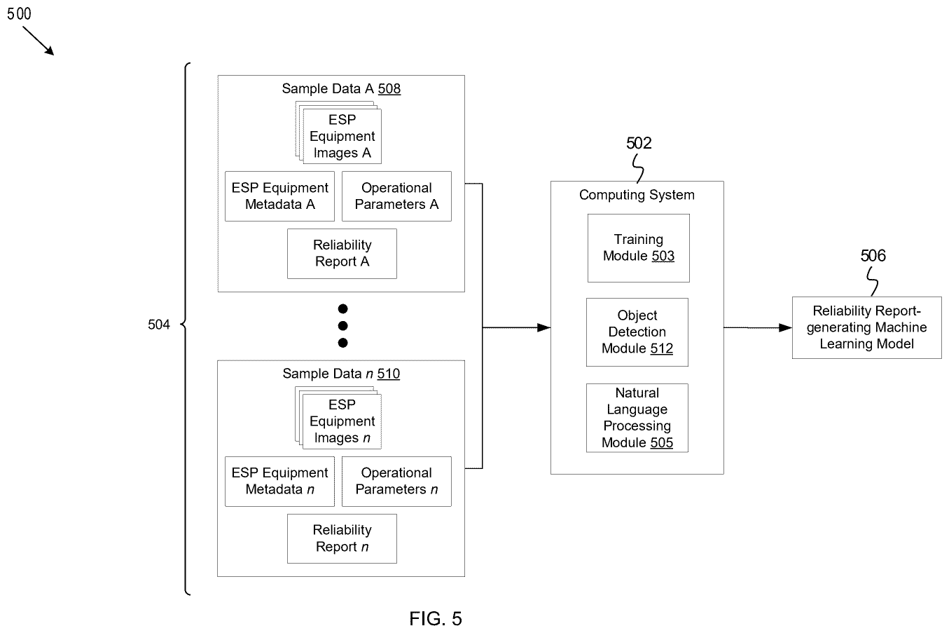

FIG. 5 is an illustration of an example system for training a reliability-report-generating machine learning module, according to some implementations. In particular, FIG. 5 depicts an example system 500 including a computing system 502, training data 504, and a reliability report-generating machine learning model 506. The computing system 502 includes a training module 503, an object detection module 512, and a natural language processing module (“NLP processing module”) 505. The training data 504 consists of sets of samples data A through n (represented by sample data A 508 and sample data n 510). The reliability report-generating machine learning model 506 can implement operations to generate reliability reports for ESP equipment.

Sample data A 508 includes ESP equipment images A, ESP equipment metadata A, operational parameters A, and a reliability report A. Sample data n 510 includes ESP equipment images n, ESP equipment metadata n, operational parameters n, and a reliability report n. Actual implementations need not include all of the data depicted and may include additional data not depicted.

In operation, the training data 504 is provided to, or retrieved by, the computing system 502. The computing system 502 provides the training data 504 as input to the training module 503, which then executes one or more operations to train the reliability report-generating machine learning model 506.

The training module 503 may use, or work in conjunction with, the object detection module 512. For example, the object detection module 512 may detect objects in the ESP equipment images A, such as impellers, shafts, and motors, and then provide indications of the detected objects to the training module 503. The detected objects may thus supplement the training data 504.

Similarly, the training module 503 may use, or work in conjunction with, the NLP module 505. For example, the NLP module 505 may identify and process text in captions embedded in the ESP equipment images A, ESP equipment metadata A, and reliability reports A, and then provide the processed text to the training module 503. The identified and processed text may thus supplement the training data 504.

Once training is complete, the training module 503 outputs the reliability report-generating machine learning model 506. The reliability report-generating machine learning model 506 can include multiple trained machine learning models as well as code usable to perform the categorization operations described herein.

Although not required, the reliability report-generating machine learning model 506 is typically persisted to a machine-readable storage medium, such as a hard drive or an object store in the cloud.

Actual implementations may not include an object detection module 512 or NLP module 505 and may include additional modules useful for processing and supplementing the training data 504.

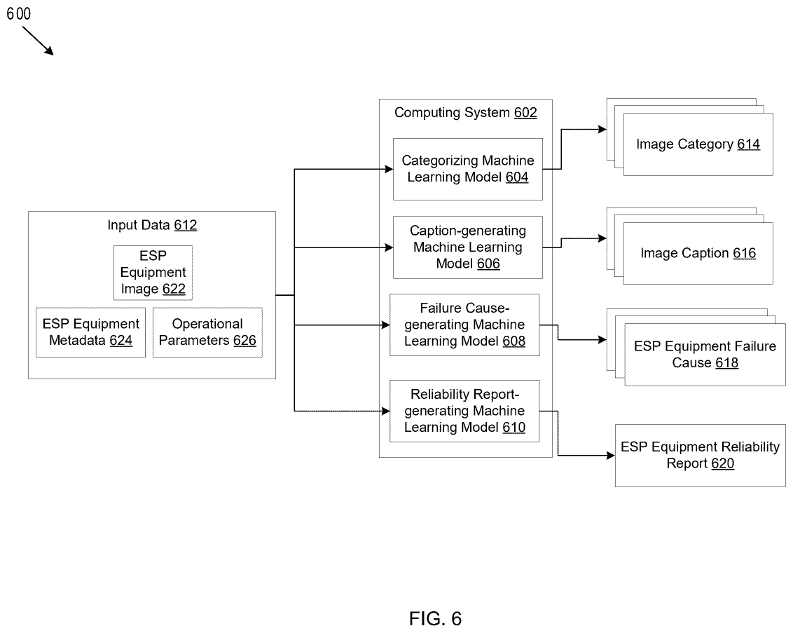

FIG. 6 depicts a system for analyzing images of ESP equipment using one or more machine learning models, according to some implementations. In particular, FIG. 6 depicts a system 600 comprising a computing system 602, input data 612, and a set of outputs comprising one or more image categories 614, one or more image captions 616, one or more ESP equipment failure causes 618, and an ESP equipment reliability report 620.

Computing system 602 includes one or more machine learning models, depicted in this example as a categorizing machine learning model 604, a caption-generating machine learning model 606, a failure cause-generating machine learning model 608, and a reliability report-generating machine learning model 610. As noted below, each of the machine learning models of computing system 602 may be included in, or work in conjunction with, one or more machine learning modules. Similarly, each machine learning model may actually be a collection of multiple machine learning modules.

The input data 612 includes an ESP equipment image 622, ESP equipment metadata 624, and operational parameters 626. The ESP equipment metadata 624 can include any metadata or information associated with the ESP equipment, such as models and specifications associated with various components of the ESP equipment. The operational parameters 626 may include any parameters associated with the operation of the ESP equipment, such as the depth at which it was placed, the flow rate, and the type of fluid flowing through the ESP equipment.

In operation, the input data 612 is provided to, or retrieved by, the computing system 602. The input data 612 is then provided as input to the one or more machine learning models. The input data 612 may be transformed or have other operations applied to it prior to being provided as input to the one or more machine learning models or the one or more machine learning models may transform or perform the operations themselves.

After receiving the input data 612, each of the machine learning models performs one or more operations and produces an output based, at least in part, on the input data 612. In this example, the categorizing machine learning model 604 outputs one or more image categories associated with the ESP equipment image 622; the caption-generating machine learning model 606 outputs one or more image captions associated with the ESP equipment image 622; the failure cause-generating machine learning model 608 outputs one or more ESP equipment failure causes 618; and the reliability report-generating machine learning model 610 outputs an ESP equipment reliability report 620.

The output from the one or more machine learning models is typically output in a manner usable by any downstream components or users. For example, the output may be displayed on a user interface for review by a user, may be stored on a machine-readable medium for later reference, may be fed as input into one of the other machine learning models, etc.

Actual implementations need not use all of the illustrated machine learning models and thus may implement a subset of the illustrated machine learning models as well as implementing machine learning models not depicted. Similarly, actual implementations that implement multiple machine learning models may implement them on separate computing systems.

The input data 612 can vary depending on the specific machine learning models implements. For example, a particular caption-generating machine learning model may only accept ESP equipment images as input. Thus, an implementation that only uses a caption-generating machine learning model may only have ESP equipment images as input. Similarly, a reliability report-generating machine learning model may work better with multiple images of the ESP equipment and thus the input data may include multiple ESP equipment images.

### Example Operations

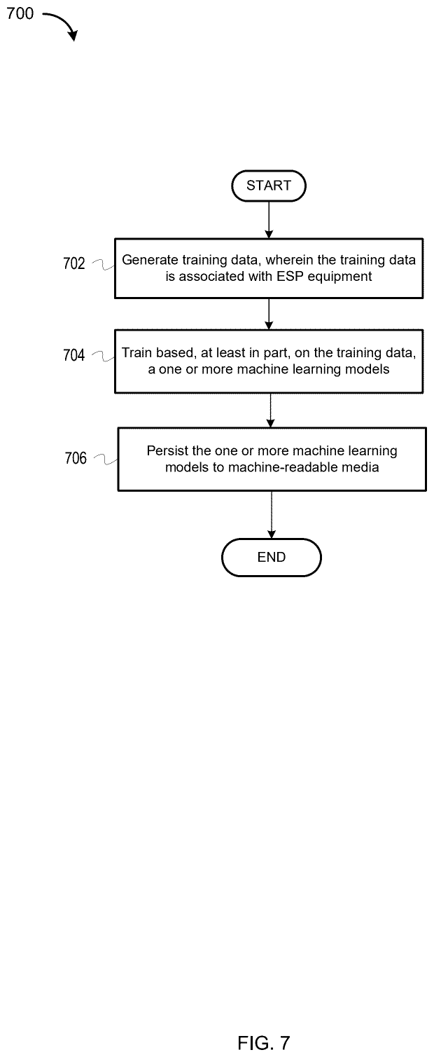

FIG. 7 depicts a flow diagram illustrating operations performed to train one or more machine learning models to work with ESP equipment images, according to some implementations. Operations depicted in the flowchart 700 of FIG. 7 can be performed by one or more computing systems (e.g., computing system 202 of FIG. 2, computing system 302 of FIG. 3, computing system 402 of FIG. 4, computing system 502 of FIG. 5) using software, firmware, hardware, or any combination thereof. The operations of flowchart 700 may be described in reference to implementations described herein but the operations can be adapted to work with any suitable implementation. Operations of flowchart 700 begin at block 702.

At block 702, training data associated with ESP equipment is generated. The training data generation process may vary depending on the specific types of training data. For example, images may be extracted from text documents, images may be transformed from one format to another, structured text may be parsed, filtered, and transformed, etc. The training data may be formatted and stored in a variety of formats, such as in a relational database or one or more text files.

The generation of the training data may include augmenting source data. For example, an image may be run through an object detection module that identifies the subjects of the image and the output from the object detection module may be stored in manner indicating the association with the image.

As another example, data may be extracted from larger collections of data and stored separately. For example, the model number of a particular piece of ESP equipment may be extracted from a specifications document and then stored as part of a database entry associated with the piece of ESP equipment.

At block 704, one or more machine learning models are trained based, at least in part, on the training data. The particular technique(s) used to train the one or more machine learning models may vary depending on the type of machine learning model being trained.

At block 706, the one or more machine learning models are persisted to machine-readable media, such as a hard disk or cloud storage.

The operations of the flowchart 700 can be adapted and/or applied to train any of the machine learning models described herein.

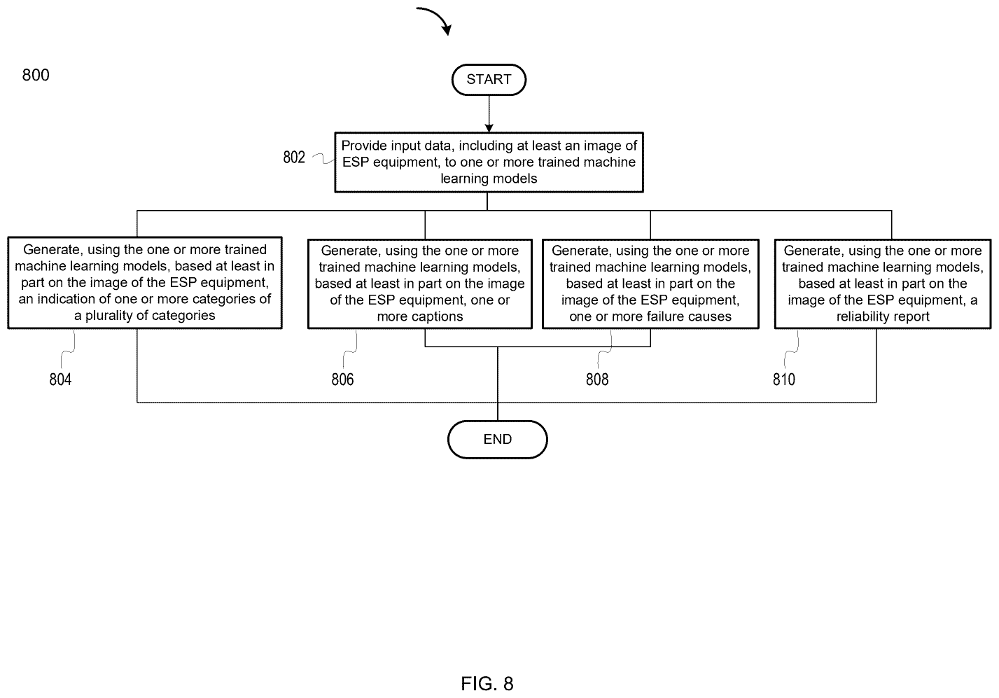

FIG. 8 depicts a flow diagram illustrating operations for analyzing ESP equipment images using one or more trained machine learning models, according to some implementations. Operations depicted in the flowchart 800 of FIG. 8 can be performed by one or more computing systems (e.g., computing system 602 of FIG. 6) using software, firmware, hardware, or any combination thereof. The operations of flowchart 800 may be described in reference to implementations described herein but the operations can be adapted to work with any suitable implementation. Operations of flowchart 800 begin at block 802.

At block 802, input data is provided to one or more trained machine learning models. The input data comprises at least an image of ESP equipment. The input data may be unmodified input data or one or more operations may be performed to transport raw input data into input data suitable for the one or more trained machine learning models. For example, the computing system 602 of FIG. 6 receives the input data 612 and provides the input data 612 to the one or more machine learning models.

At block 804, indications of one or more categories of a plurality of categories are generated by the one or more trained machine learning models based, at least in part, on the image of the ESP equipment. The specific form that the indications take may vary depending on the one or more machine learning models used and how the machine learning models were trained. For example, the indications may be textual or numeric.

As an example, the categorizing machine learning model 604 in FIG. 6 outputs one or more image categories 614 based on the ESP equipment image 622.

At block 806, one or more captions are generated by the one or more trained machine learning models based, at least in part, on the image of the ESP equipment. As an example, the caption-generating machine learning model 606 of FIG. 6 outputs one or more image captions 616.

At block 808, one or more failure causes are generated by the one or more trained machine learning models based, at least in part, on the image of the ESP equipment. As an example, the failure cause-generating machine learning model 608 of FIG. 6 outputs one or more ESP equipment failure causes 618.

At block 810, a reliability report is generated by the one or more trained machine learning models based, at least in part, on the image of the ESP equipment. As an example, the reliability report-generating machine learning model 610 of FIG. 6 outputs the ESP equipment reliability report 620.

An actual implementation may not implement all operations depicted in the flowchart 800. For example, some implementations may only implement a categorizing machine learning model and thus may only implement the operations of block 802 and block 804. Thus, implementations may perform some of the operations depicted in the flowchart 800. Implementations may also perform additional operations that are not depicted in the flowchart 800 or may not perform the operations in parallel. For example, some implementations may utilize the outputs of one or more of the machine learning models as input to other machine learning models. For example, captions generated by a caption-generating machine learning model may be usable by a failure cause-generating machine learning model to determine a failure cause.

The one or more machine learning models may be incorporated into one or more machine learning modules that are capable of performing one or more operations to support the machine learning models. For example, a machine learning module may perform data acquisition operations, data transformation operations, operations to load and or configure the one or more machine learning models, etc. A machine learning module may also be capable of performing one or more operations to train or retrain the incorporated machine learning models. In some implementations, the machine learning model is not incorporated into the machine learning module but works in conjunction with the machine learning module. The operations describe herein can be adapted for implementations in which a machine learning model is incorporated into one or more machine learning modules, implementations in which a machine learning model works in conjunction with one or more machine learning modules, or any other appropriate implementation. References herein to “machine learning models” should thus be interpreted to include program code and other resources used to support the operation of the machine learning models.

It should be noted that the descriptions herein describe one or more machine learning models generating one or more indications of a failure cause. However, the operations described herein may be applied to ESP equipment that has not failed. For example, if ESP equipment is retired (e.g., due to age) but has not actually failed, the operations described herein may be used to determine whether the retired ESP equipment exhibits signs of impending failure and what types of failures.

It should further be noted that although the descriptions herein may refer to machine learning modules making determinations or generating various outputs, it is understood that machine learning and similar techniques may actually generate probabilities associated with particular outputs. Further, the machine learning modules may be implemented such that probabilities over certain thresholds are presented without reference to their probabilities.

The term “ESP equipment” includes electrical submersible pumps themselves as well as any related equipment that supports the operation of the electrical submersible pumps themselves.

Although the descriptions above refer to images of ESP equipment, the subject matter is not so limited and may be adapted for different types of images. For example, the operations described herein may be applied to images created by devices and systems like scanning electron microscopes and other imaging devices, charts and graphs of sensor or measurement device outputs, etc.

While the aspects of the disclosure are described with reference to various implementations and exploitations, it will be understood that these aspects are illustrative and that the scope of the claims is not limited to them. In general, techniques for detecting subsurface conditions using tube waves as described herein may be implemented with facilities consistent with any hardware system or hardware systems. Many variations, modifications, additions, and improvements are possible.

Plural instances may be provided for components, operations or structures described herein as a single instance. Further, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

### Example Computer

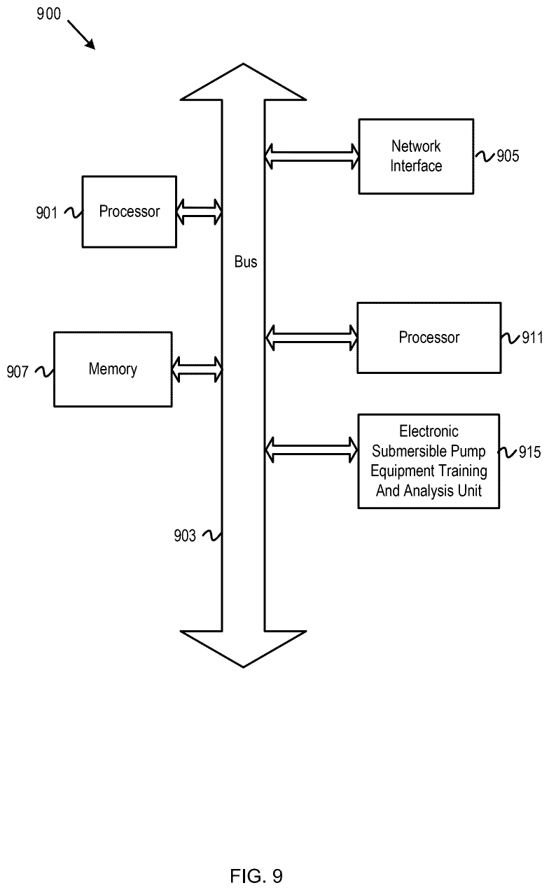

FIG. 9 is a block diagram depicting an example computer, according to some implementations. FIG. 9 depicts a computer 900 for ESP equipment failure analysis. The computer 900 includes a processor 901 (possibly including multiple processors, multiple cores, multiple nodes, and/or implementing multi-threading, etc.). The computer 900 also includes an ESP equipment training and analysis unit 915 which may perform the operations described herein. For example, the ESP equipment training and analysis unit 915 may generate training data associated with ESP equipment; train one or more machine learning models, based at least in part, on the training data; persist the one or more machine learning models to machine-readable media; provide input data including at least an image of ESP equipment, to the one or more machine learning models; and generate categories, captions, failure causes, or reliability reports based, at least in part, on the image of ESP equipment. Any one of the previously described functionalities may be partially (or entirely) implemented in hardware and/or on ESP equipment training and analysis unit 915. For example, the functionality may be implemented with an application specific integrated circuit, in logic implemented in the ESP equipment training and analysis unit 915, in a co-processor on a peripheral device or card, etc. Further, realizations may include fewer or additional components not illustrated in FIG. 9 (e.g., video cards, audio cards, additional network interfaces, peripheral devices, etc.). The processor 901 and the network interface 905 are coupled to the bus 903. Although illustrated as being coupled to the bus 903, the memory 907 may be coupled to the processor 901. The computer 900 includes memory 907. The memory 907 may be system memory or any one or more possible realizations of machine-readable media. The computer 900 can communicate via transmissions to and/or from remote devices via the network interface 905 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

### Example Implementations

Implementation 1: A method for electrical submersible pump equipment fault analysis, the method comprising training, using first training data, one or more machine learning models to categorize previously unseen images of electrical submersible pump equipment into one or categories of a plurality of categories; and training, using second training data, the one or more machine learning models to generate captions for the previously unseen images of electrical submersible pump equipment.

Implementation 2: The method according to any of the preceding Implementations, the method further comprising training, using third training data, the one or more machine learning models to determine a cause of a failure.

Implementation 3: The method according to any of the preceding Implementations, further comprising providing a plurality of images of electrical submersible pump equipment as input to a machine learning model of the one or more machine learning models, wherein the first training data, the second training data, and the third training data do not include the plurality of images of the electrical submersible pump equipment; and generating, using the machine learning model, a failure cause based, at least in part, on the plurality of images of the electrical submersible pump equipment.

Implementation 4: The method according to any of the preceding Implementations, further comprising generating, using the one or more machine learning models, a reliability report based, at least in part, on the plurality of images of electrical submersible pump equipment.

Implementation 5: The method according to any of the preceding Implementations, the method further comprising providing an image of electrical submersible pump equipment as input to a machine learning model of the one or more machine learning models, wherein the first training data does not include the image of the electrical submersible pump equipment; and generating, using the machine learning model, an indication of a category of the plurality of categories.

Implementation 6: The method according to any of the preceding Implementations, the method further comprising providing an image of electrical submersible pump equipment as input to a machine learning model of the one or more machine learning models, wherein the second training data does not include the image of the electrical submersible pump equipment; and generating, using the machine learning model, a caption corresponding to the image of the electrical submersible pump equipment.

Implementation 7: The method according to any of the preceding Implementations, wherein the first training data comprises at least a first plurality of images of electrical submersible pump equipment and the second training data comprises at least a second plurality of images of electrical submersible pump equipment with associated captions.

Implementation 8: A computing system comprising one or more processors; and one or more non-transitory computer-readable mediums including instructions which, when executed by the one or more processors, cause the one or more processors to execute one or more operations for electrical submersible pump equipment fault analysis, the instructions including instructions to train, using first training data, one or more machine learning models to categorize previously unseen images of electrical submersible pump equipment into one or categories of a plurality of categories; and instructions to train, using second training data, the one or more machine learning models to generate captions for the previously unseen images of electrical submersible pump equipment.

Implementation 9: The computing system according to any of the preceding Implementations, the instructions further including instructions to train, using third training data, the one or more machine learning models to determine a cause of a failure.

Implementation 10: The computing system according to any of the preceding Implementations, the instructions further including instructions to provide a plurality of images of electrical submersible pump equipment as input to a machine learning model of the one or more machine learning models, wherein the first training data, the second training data, and the third training data do not include the plurality of images of the electrical submersible pump equipment; and instructions to generate, using the machine learning model, a failure cause based, at least in part, on the plurality of images of the electrical submersible pump equipment.

Implementation 11: The computing system according to any of the preceding Implementations, the instructions further comprising instructions to generate, using the one or more machine learning models, a reliability report based, at least in part, on the plurality of images of electrical submersible pump equipment.

Implementation 12: The computing system according to any of the preceding Implementations, the instructions further including instructions to provide an image of electrical submersible pump equipment as input to a machine learning model of the one or more machine learning models, wherein the first training data does not include the image of the electrical submersible pump equipment; and instructions to generate, using the machine learning model, an indication of a category of the plurality of categories.

Implementation 13: The computing system according to any of the preceding Implementations, the instructions further including instructions to provide an image of electrical submersible pump equipment as input to a machine learning model of the one or more machine learning models, wherein the second training data does not include the image of the electrical submersible pump equipment; and instructions to generate, using the machine learning model, a caption corresponding to the image of the electrical submersible pump equipment.

Implementation 14: The computing system according to any of the preceding Implementations, wherein the first training data comprises at least a first plurality of images of electrical submersible pump equipment and the second training data comprises at least a second plurality of images of electrical submersible pump equipment with associated captions.

Implementation 15: One or more non-transitory computer-readable mediums including instructions which, when executed by a processor, cause the processor to execute one or more operations for electrical submersible pump equipment fault analysis, the instructions comprising instructions to train, using first training data, one or more machine learning models to categorize previously unseen images of electrical submersible pump equipment into one or categories of a plurality of categories; and instructions to train, using second training data, the one or more machine learning models to generate captions for the previously unseen images of electrical submersible pump equipment.

Implementation 16: The one or more non-transitory computer-readable mediums according to any of the preceding Implementations, the instructions further including instructions to train, using third training data, the one or more machine learning models to determine a cause of a failure.

Implementation 17: The one or more non-transitory computer-readable mediums according to any of the preceding Implementations, the instructions further including instructions to provide a plurality of images of electrical submersible pump equipment as input to a machine learning model of the one or more machine learning models, wherein the first training data, the second training data, and the third training data do not include the plurality of images of the electrical submersible pump equipment; and instructions to generate, using the machine learning model, a failure cause based, at least in part, on the plurality of images of the electrical submersible pump equipment.

Implementation 18: The one or more non-transitory computer-readable mediums according to any of the preceding Implementations, the instructions further comprising instructions to generate, using the one or more machine learning models, a reliability report based, at least in part, on the plurality of images of electrical submersible pump equipment.

Implementation 19: The one or more non-transitory computer-readable mediums according to any of the preceding Implementations, the instructions further including: instructions to provide an image of electrical submersible pump equipment as input to a machine learning model of the one or more machine learning models, wherein the first training data does not include the image of the electrical submersible pump equipment; and instructions to generate, using the machine learning model, an indication of a category of the plurality of categories.

Implementation 20: The one or more non-transitory computer-readable mediums according to any of the preceding Implementations, the instructions further including: instructions to provide an image of electrical submersible pump equipment as input to a machine learning model of the one or more machine learning models, wherein the second training data does not include the image of the electrical submersible pump equipment; and instructions to generate, using the machine learning model, a caption corresponding to the image of the electrical submersible pump equipment.

1. A method for electrical submersible pump equipment fault analysis, the method comprising:
training, using first training data, one or more machine learning models to categorize previously unseen images of electrical submersible pump equipment into one or categories of a plurality of categories; and
training, using second training data, the one or more machine learning models to generate captions for the previously unseen images of electrical submersible pump equipment.

2. The method of claim 1, the method further comprising:
training, using third training data, the one or more machine learning models to determine a cause of a failure.

3. The method of claim 2, further comprising:
providing a plurality of images of electrical submersible pump equipment as input to a machine learning model of the one or more machine learning models, wherein the first training data, the second training data, and the third training data do not include the plurality of images of the electrical submersible pump equipment; and
generating, using the machine learning model, a failure cause based, at least in part, on the plurality of images of the electrical submersible pump equipment.

4. The method of claim 3, further comprising generating, using the one or more machine learning models, a reliability report based, at least in part, on the plurality of images of electrical submersible pump equipment.

5. The method of claim 1, the method further comprising:
providing an image of electrical submersible pump equipment as input to a machine learning model of the one or more machine learning models, wherein the first training data does not include the image of the electrical submersible pump equipment; and
generating, using the machine learning model, an indication of a category of the plurality of categories.

6. The method of claim 1, the method further comprising:
providing an image of electrical submersible pump equipment as input to a machine learning model of the one or more machine learning models, wherein the second training data does not include the image of the electrical submersible pump equipment; and
generating, using the machine learning model, a caption corresponding to the image of the electrical submersible pump equipment.

7. The method of claim 1, wherein the first training data comprises at least a first plurality of images of electrical submersible pump equipment and the second training data comprises at least a second plurality of images of electrical submersible pump equipment with associated captions.

8. A computing system comprising:
one or more processors; and
one or more non-transitory computer-readable mediums including instructions which, when executed by the one or more processors, cause the one or more processors to execute one or more operations for electrical submersible pump equipment fault analysis, the instructions including:
instructions to train, using first training data, one or more machine learning models to categorize previously unseen images of electrical submersible pump equipment into one or categories of a plurality of categories; and
instructions to train, using second training data, the one or more machine learning models to generate captions for the previously unseen images of electrical submersible pump equipment.

9. The computing system of claim 8, the instructions further including instructions to train, using third training data, the one or more machine learning models to determine a cause of a failure.

10. The computing system of claim 9, the instructions further including:
instructions to provide a plurality of images of electrical submersible pump equipment as input to a machine learning model of the one or more machine learning models, wherein the first training data, the second training data, and the third training data do not include the plurality of images of the electrical submersible pump equipment; and
instructions to generate, using the machine learning model, a failure cause based, at least in part, on the plurality of images of the electrical submersible pump equipment.

11. The computing system of claim 10, the instructions further comprising instructions to generate, using the one or more machine learning models, a reliability report based, at least in part, on the plurality of images of electrical submersible pump equipment.

12. The computing system of claim 8, the instructions further including:
instructions to provide an image of electrical submersible pump equipment as input to a machine learning model of the one or more machine learning models, wherein the first training data does not include the image of the electrical submersible pump equipment; and
instructions to generate, using the machine learning model, an indication of a category of the plurality of categories.

13. The computing system of claim 8, the instructions further including:
instructions to provide an image of electrical submersible pump equipment as input to a machine learning model of the one or more machine learning models, wherein the second training data does not include the image of the electrical submersible pump equipment; and
instructions to generate, using the machine learning model, a caption corresponding to the image of the electrical submersible pump equipment.

14. The computing system of claim 8, wherein the first training data comprises at least a first plurality of images of electrical submersible pump equipment and the second training data comprises at least a second plurality of images of electrical submersible pump equipment with associated captions.

15. One or more non-transitory computer-readable mediums including instructions which, when executed by a processor, cause the processor to execute one or more operations for electrical submersible pump equipment fault analysis, the instructions comprising:
instructions to train, using first training data, one or more machine learning models to categorize previously unseen images of electrical submersible pump equipment into one or categories of a plurality of categories; and
instructions to train, using second training data, the one or more machine learning models to generate captions for the previously unseen images of electrical submersible pump equipment.

16. The one or more non-transitory computer-readable mediums of claim 15, the instructions further including instructions to train, using third training data, the one or more machine learning models to determine a cause of a failure.

17. The one or more non-transitory computer-readable mediums of claim 16, the instructions further including:
instructions to provide a plurality of images of electrical submersible pump equipment as input to a machine learning model of the one or more machine learning models, wherein the first training data, the second training data, and the third training data do not include the plurality of images of the electrical submersible pump equipment; and
instructions to generate, using the machine learning model, a failure cause based, at least in part, on the plurality of images of the electrical submersible pump equipment.

18. The one or more non-transitory computer-readable mediums of claim 17, the instructions further comprising instructions to generate, using the one or more machine learning models, a reliability report based, at least in part, on the plurality of images of electrical submersible pump equipment.

19. The one or more non-transitory computer-readable mediums of claim 15, the instructions further including:
instructions to provide an image of electrical submersible pump equipment as input to a machine learning model of the one or more machine learning models, wherein the first training data does not include the image of the electrical submersible pump equipment; and
instructions to generate, using the machine learning model, an indication of a category of the plurality of categories.

20. The one or more non-transitory computer-readable mediums of claim 15, the instructions further including:
instructions to provide an image of electrical submersible pump equipment as input to a machine learning model of the one or more machine learning models, wherein the second training data does not include the image of the electrical submersible pump equipment; and
instructions to generate, using the machine learning model, a caption corresponding to the image of the electrical submersible pump equipment.
